(19) United States
(12) Patent Application Publication
(10) Pub. No.: US 2022/0334297 A1
(43) Pub. Date: Oct. 20, 2022

(54) CONDUCTIVE OPTICAL FILM AND METHOD FOR MANUFACTURING SAME

(71) Applicant: SG FLEXIO CO.,LTD., Daejeon (KR)

(72) Inventors: Chang Woo SEO, Sejong (KR); Sang Mann LEE, Daejeon (KR); Ji Ni LEE, Daejeon (KR); Min Gyun GIL, Daejeon (KR); Hong-seok HA, Chungcheongnam-do (KR); Young Sun KWON, Daejeon (KR)

(21) Appl. No.: 17/753,544

(22) PCT Filed: Sep. 9, 2020
(86) PCT No.: PCT/KR2020/012168

§ 371 Date: Mar. 7, 2022

(30) Foreign Application Priority Data
Sep. 9, 2019 (KR) 10-2019-0111573

(51) Int. Cl. G02B 5/20; G02B 1/04; B29D 11/00

(52) U.S. Cl. CPC G02B 5/208; G02B 1/04; B29D 11/00634; B29D 11/00865; B82Y 20/00

(57) ABSTRACT

An optical film according to the present disclosure comprises: a transparent substrate; a network of conductive nanowires positioned on at least one surface of the transparent substrate; and an organic binder, wherein the organic binder includes a first organic binder and a second organic binder having different solubility parameters (Hildebrand solubility parameter, δ) from each other, a difference in the solubility parameter between the first organic binder and the second organic binder being 5 MPa^{0.5} or more, and the optical film has a haze of 2.0% or less and a sheet resistance of 25 Ω/sq or less.

### TECHNICAL FIELD

The present disclosure relates to a conductive optical film and a method for manufacturing the same.

### BACKGROUND AND SUMMARY

Various display devices such as LCD, LED, OLED, and QLED are being developed in order to secure an excellent contrast ratio, a high resolution, an improved brightness, and an excellent color volume, and according to the technology development, a demand for an optical film which satisfies more diverse properties simultaneously in the fields such as a display device is increasing.

The present disclosure is a kind of optical film having complex physical properties as such, and provides an optical film satisfying both excellent optical properties and electrical properties.

### DISCLOSURE

### Technical Problem

An object of the present disclosure is to provide an optical film satisfying both excellent optical properties and electrical properties.

### Technical Solution

In one general aspect, an optical film includes: a transparent substrate; a network of conductive nanowires positioned on at least one surface of the transparent substrate; and an organic binder, wherein the organic binder includes a first organic binder and a second organic binder with different solubility parameters (δ) from each other, a difference in the solubility parameter between the first organic binder and the second organic binder being 5 MPa^{0.5} or more, and the optical film has a haze of 2.0% or less and a sheet resistance of 25 Ω/sq or less.

In the optical film according to an exemplary embodiment of the present disclosure, the optical film may have a sheet resistance uniformity which is defined by the following Equation 1 and satisfies the following Equation 2:

Sheet resistance uniformity (%)=[1−(standard deviation of sheet resistance)/average of sheet resistance]×100 Equation 1

90(%)≤sheet resistance uniformity (%). Equation 2

In the optical film according to an exemplary embodiment of the present disclosure, in a UV-Vis absorption spectrum of the optical film, a center of an absorption peak may be positioned in a wavelength region of 350 to 360 nm.

In the optical film according to an exemplary embodiment of the present disclosure, in the UV-Vis absorption spectrum of the optical film, no center of the absorption peak may be positioned in a wavelength region of 365 nm to 385 nm.

In the optical film according to an exemplary embodiment of the present disclosure, the network of conductive nanowires may be a network formed by a physical mutual contact of randomly positioned metal nanowires.

In the optical film according to an exemplary embodiment of the present disclosure, the optical film may include 10 to 1000 parts by weight of the organic binder, with respect to 100 parts by weight of a total weight of the conductive nanowires forming the network.

In the optical film according to an exemplary embodiment of the present disclosure, the first organic binder having a relatively high solubility parameter has a solubility parameter of 22.0 MPa^{0.5} or more.

In the optical film according to an exemplary embodiment of the present disclosure, the sheet resistance may be 20 Ω/sq or less.

In the optical film according to an exemplary embodiment of the present disclosure, the conductive nanowires may be silver nanowires.

In the optical film according to an exemplary embodiment of the present disclosure, the conductive metal nanowires may have a diameter of 10 to 30 nm.

In another general aspect, a display device includes the optical film described above.

In another general aspect, a method for manufacturing the optical film described above includes the following:

a) applying a coating solution including conductive nanowires, an organic binder, and a solvent on at least one surface of a transparent substrate to prepare a coating film; and b) cleaning the one surface of the transparent substrate having the coating film positioned thereon.

In the method for manufacturing an optical film according to an exemplary embodiment of the present disclosure, the cleaning in step b) may be one or two or more selected from dry cleaning, wet cleaning, and steam cleaning.

In the method for manufacturing an optical film according to an exemplary embodiment of the present disclosure, the cleaning may include spraying a cleaning solution including a polar solvent.

In the method for manufacturing an optical film according to an exemplary embodiment of the present disclosure, the cleaning solution may have a solubility parameter of 20 MPa^{0.5} or more.

The method for manufacturing an optical film according to an exemplary embodiment of the present disclosure may further include, before step b), after step b), or before and after step b), respectively, heat-treating the transparent substrate having the conductive nanowires positioned on the one surface by the application of the coating solution.

### Advantageous Effects

The optical film according to the present disclosure has uniform and excellent electrical properties even on a large area, excellent optical properties, and conductivity by nanowires, and thus, has excellent flexibility.

### BRIEF DESCRIPTION OF THE FIGURES

FIG. 1 is a drawing illustrating a UV-Vis absorption spectrum before/after cleaning of an optical film.

### DETAILED DESCRIPTION

### Best Mode

Hereinafter, the optical film of the present disclosure and a method for manufacturing the same will be described in detail with reference to the accompanying drawings. The drawings to be provided below are provided by way of example so that the idea of the present disclosure can be sufficiently transferred to a person skilled in the art to which the present disclosure pertains. Therefore, the present disclosure is not limited to the drawings provided below but may be embodied in many different forms, and the drawings suggested below may be exaggerated in order to clarify the spirit of the present disclosure. Herein, technical terms and scientific terms used in the present specification have the general meaning understood by those skilled in the art to which the present disclosure pertains unless otherwise defined, and a description for the known function and configuration unnecessarily obscuring the gist of the present disclosure will be omitted in the following description and the accompanying drawings. In addition, the singular form used in the specification appended thereto may be intended to also include a plural form, unless otherwise indicated in the context. Units used in the present specification without particular mention are based on weights, and as an example, a unit of % or ratio refers to a wt % or a weight ratio. In addition, unless particularly described by being limited to an embodiment, the description above may be applied to each of all embodiments.

The applicant noted that in the course of conducting a study on a nanowire-based optical film, the optical properties of a film are damaged by an organic binder which is essentially introduced for securing uniform and excellent electrical properties even on a large area, and found that when an optical film is manufactured using two or more different organic binders, the organic binder is partially removed in the manufacturing process, thereby improving both the optical properties and the electrical properties of the film, and also, stably maintaining a state in which the nanowires are bound to the substrate, and thus, has completed the present disclosure.

The optical film according to an exemplary embodiment of the present disclosure based on the discovery is an optical film including a transparent substrate; a network of conductive nanowires positioned on at least one surface of the transparent substrate; and an organic binder, wherein the optical film satisfies a sheet resistance (Rs) of 25 (Ω/sq) or less, a sheet resistance uniformity which is defined by the following Equation 1 and satisfies the following Equation 2, and a haze (H) of 2.0(%) or more:

Sheet resistance uniformity (%)=[1−(standard deviation of sheet resistance)/average of sheet resistance]×100 Equation 1

90(%)≤sheet resistance uniformity (%). Equation 2

The optical film according to another exemplary embodiment of the present disclosure based on the discovery is an optical film including a transparent substrate; a network of conductive nanowires positioned on at least one surface of the transparent substrate; and an organic binder, wherein the organic binder includes a first organic binder and a second organic binder with different solubility parameters from each other, a difference in the solubility parameter between the first optical film and the second organic binder being 5 MPa^{0.5} or more.

The optical film according to another exemplary embodiment of the present disclosure based on the discovery is an optical film including: a transparent substrate; a network of conductive nanowires positioned on at least one surface of the transparent substrate; and an organic binder, wherein in a UV-Vis absorption spectrum of the optical film, no absorption peak is present in a wavelength region of 365 nm to 385 nm.

The optical film according to another exemplary embodiment of the present disclosure based on the discovery is an optical film including a transparent substrate; a network of conductive nanowires positioned on at least one surface of the transparent substrate; and an organic binder, wherein in the UV-Vis absorption spectrum of the optical film, no absorption peak is present in a wavelength region of 365 nm to 385 nm, and a center of the absorption peak is present in a wavelength region of 350 to 360 nm.

The optical film according to an exemplary embodiment of the present disclosure is an optical film including: a transparent substrate; a network of conductive nanowires positioned on at least one surface of the transparent substrate; and an organic binder, wherein the organic binder includes a first organic binder and a second organic binder with different solubility parameters from each other, a difference in the solubility parameter (Hildebrand solubility parameter, 6) between the first organic binder and the second organic binder being 5 MPa^{0.5} or more, and the optical film has a haze of 2.0% or less and a sheet resistance of 25 Ω/sq or less.

In an exemplary embodiment, the optical film may have a sheet resistance uniformity which is defined by the following Equation 1 and satisfies the following Equation 2:

Sheet resistance uniformity (%)=[1−(standard deviation of sheet resistance)/average of sheet resistance]×100 Equation 1

90(%)≤sheet resistance uniformity (%). Equation 2

In an exemplary embodiment, in a UV-Vis absorption spectrum of the optical film, a center of an absorption peak may be positioned in a wavelength region of 350 to 360 nm.

In an exemplary embodiment, in the UV-Vis absorption spectrum of the optical film, no center of the absorption peak may be positioned in a wavelength region of 365 nm to 385 nm.

Specifically, the transparent substrate may be a transparent insulating film, and the transparent insulating film may include one or two or more selected from the group consisting of polyacrylate, polyimide, polycarbonate, polyester, polypropylene, polyethylene, acryl, polyethylene terephthalate, epoxy, cellulose triacetate (TAC), polyvinyl acetate, and polypropylene, or may be a lamination film in which each film of two or more materials selected therefrom is laminated, but the present disclosure is not limited thereto.

In the network of conductive nanowires, the conductive nanowires may metal nanowires, and the metal may be one or two or more selected from gold, silver, copper, lithium, aluminum, and alloys thereof, but is not limited thereto. The conductive nanowires are silver nanowires, so that a conductivity (sheet resistance) to be desired may be obtained by a simple physical contact.

The conductive nanowires may have a diameter (short axis diameter) of 3 to 50 nm, 5 to 40 nm, 10 to 30 nm, 10 to 25 nm, or 15 to 25 nm, but is not limited thereto. The conductive nanowires may have an aspect ratio (long axis length/short axis diameter) of 5 to 2000 or 50 to 2000, but is not limited thereto.

In the optical film, a density (loading amount) of the conductive nanowires which is a mass of the conductive nanowires positioned per unit area of the transparent substrate may be 0.01 to 0.2 g/m², but is not limited thereto.

In an exemplary embodiment of the present disclosure, the network of conductive nanowires may refer to a structure in which a continuous charge transfer path is provided by a physical contact between conductive nanowires. Specifically, the network of conductive nanowires may be a network formed by a physical mutual contact of randomly positioned metal nanowires on one surface of the transparent substrate. Here, the network of conductive nanowires is not a structure which is physically integrated by welding of areas where the conductive nanowires are in contact with each other by light sintering or heat application but a structure in which individual conductive nanowires are only physically in contact with each other.

The optical film may have a sheet resistance (Rs) of 25 Ω/sq or less, specifically, 10 to 25 Ω/sq, and more specifically 15 to 20 Ω/sq.

The optical film may have a sheet resistance uniformity of 90% or more, the sheet resistance uniformity being defined by an equation of “sheet resistance uniformity (%)=[1−(standard deviation of sheet resistance)/average of sheet resistance]]×100”. Here, the sheet resistance uniformity may be obtained by equally dividing an optical film having an area of at least 20 mm×20 mm into 9 or more areas, and measuring the sheet resistance randomly 10 times or more for each divided area.

The optical film may have a haze satisfying 2.0% or less, specifically 1.0 to 2.0%, more specifically 1.0 to 1.8%, and more specifically 1.0 to 1.7%. Here, the haze may be measured in accordance with ASTM D 1003.

The organic binder included in the optical film may include a first optical film and a second optical film with different solubility parameters (δ) from each other. The first organic binder may be a binder having a relatively high solubility parameter and the second organic binder may be a binder having a relatively low solubility parameter. The solubility parameter may be based on room temperature (25° C.). A method of determining the solubility parameter is not particularly limited, and a method known in the art may be followed. For example, the solubility parameter may be calculated or determined according to a method known as so called Hansen solubility parameter (HSP) in the art. Specifically, since HSP has a known information source such as data base, the Hansen solubility parameter (HSP) of a material may be obtained, for example, with reference to the database. The HSP of a material of which the HSP is not registered in the data base may be obtained by using a computer program such as, for example, Hansen Solubility Parameters in Practice (HSPiP).

A difference in the solubility parameter between the first organic binder and the second organic binder may be 5 MPa^{0.5} or more, specifically 6 MPa^{0.5} or more, as an example, 5 to 25 MPa^{0.5}, 5 to 20 MPa^{0.5}, 5 to 15 MPa^{0.5}, 6 to 25 MPa^{0.5}, 6 to 20 MPa^{0.5}, or 6 to 15 MPa^{0.5}. When the difference in the solubility parameter is too large, it may be difficult to dissolve both the first organic binder and the second organic binder in appropriate amounts in a single solvent. In addition, when the difference in the solubility parameter is too small, that is, the solubility parameters of the first organic binder and the second organic binder are similar to each other, it is difficult to selectively remove one organic binder of the first organic binder and the second organic binder, and thus, optical properties and electrical properties may not be improved.

The solubility parameter of the first organic binder having a relatively high solubility parameter of the two organic binders may be 22.0 MPa^{0.5} or more, specifically 23 MPa^{0.5} or more. Here, the upper limit of the solubility parameter of the first organic binder is not particularly limited, but may be 50.0 MPa^{0.5} or less, specifically 45 MPa^{0.5} or less, and more specifically 40 MPa^{0.5} or less. When the first organic binder satisfies the solubility parameter described above and the second organic binder satisfies the difference in the solubility parameter described above, both the first organic binder and the second organic binder may be stably dissolved in a polar solvent having a solubility parameter of 20 MPa^{0.5} or more like water, and as described later, electrical and optical properties may be improved by mainly removing the first organic binder by cleaning.

The first organic binder and the second organic binder satisfy the difference in the solubility parameter described above, and may be any organic polymer which is dissolved in a polar solvent having a solubility parameter of 20 MPa^{0.5} or more at 0.01 wt % or more, specifically at least 0.1 wt % or more, and more specifically at least 2.5 wt % or more, respectively.

As an example, the first organic binder may be one or two or more selected from polyethylene glycol (PEG), polyimideamide (PAI), polyvinylpyrrolidone (PVP), polyethylene (PE), polypropylene (PVP), polyvinyl alcohol (PVA), polyacrylic acid (PAA), polyvinylidene fluoride (PVdF), polyhydroxyethylmethacrylate (PHEMA), styrene-butadiene rubber (SBR), styrene, and the like.

As an example, the second organic binder may be one or two or more selected from cellulose ester and cellulose ether. The cellulose ether may include carboxy-C1-C3-alkyl cellulose, carboxy-C1-C3-alkyl hydroxy-C1-C3-alkyl cellulose, C1-C3-alkyl cellulose, C1-C3-alkyl hydroxy-C1-C3-alkyl cellulose, hydroxy-C1-C3-alkyl cellulose, mixed hydroxy-C1-C3-alkyl cellulose, or a mixture thereof. As an example, carboxy-C1-C3-alkyl cellulose may include carboxymethyl cellulose and the like, carboxy-C1-C3-alkyl hydroxy-C1-C3-alkyl cellulose may include carboxymethyl hydroxyethyl cellulose and the like, C1-C3-alkyl cellulose may include methylcellulose and the like, C1-C3-alkyl hydroxy-C1-C3-alkyl cellulose may include hydroxyethyl methylcellulose, hydroxypropyl methylcellulose, ethyl hydroxyethyl cellulose, or a combination thereof, hydroxy-C1-C3-alkyl cellulose may include hydroxyethyl cellulose, hydroxypropyl cellulose, or a combination thereof, and mixed hydroxy-C1-C3-alkyl cellulose may include hydroxyethyl hydroxypropyl cellulose, alkoxy hydroxyethyl hydroxypropyl cellulose (the alkoxy group is a straight chain or branched chain and has 2 to 8 carbon atoms) or the like.

The organic binder (first organic binder or second organic binder) may have a molecular weight (Mw) of 3,000 to 500,000, but is not limited thereto. The optical film may not include a separate dispersing agent, and only include an organic binder as an organic material.

The optical film may have an absorption peak (first peak) positioned in a wavelength region of 350 to 360 nm, specifically in a wavelength region of 352 to 358 nm on a UV-Vis absorption spectrum (absorbance depending on wavelength).

Also, or independently of this, the optical film may have no center of an absorption peak positioned in a wavelength region of 365 nm to 386 nm, specifically 365 to 380 nm, and more specifically 367 to 377 nm on the UV-Vis absorption spectrum.

Here, the UV-Vis absorption spectrum of the optical film may be a raw UV-Vis absorption spectrum obtained by detection by a light detector, which is not decomposed for each peak by Gaussian and/or Lorentzian distribution and the like, when two or more absorption peaks adjacent to each other overlap each other. Thus, the UV-Vis absorption spectrum may have a multimodal shape in which absorption peaks overlap, and the center of the absorption peaks (center wavelength) may correspond to the wavelength of each modal in the multimodal shaped spectrum.

Also, the optical film may have an absorption peak (second peak) in a wavelength region of 330 to 345 nm, specifically 335 to 344 nm, but the strength of the second peak may be smaller than the strength of the first peak. As an example, the first peak may be an absorption peak having a maximum strength in a wavelength region of 330 to 385 nm.

The UV-Vis absorption spectrum is a spectrum which shows when a solution including the conductive nanowires, the first organic binder, and the second organic binder is applied, and then the organic binder (first organic binder) having a higher solubility parameter is mostly removed by cleaning to remove the binder positioned on the surface of the transparent substrate, and also, a contact between the binder and the nanowires disappears and a new contact between nanowires is produced.

The optical film may include 10 to 1000 parts by weight, 10 to 500 parts by weight, 10 to 200 parts by weight, 10 to 150 parts by weight, 10 to 100 parts by weight, or 10 to 80 parts by weight, with respect to 100 parts by weight of the total weight of the conductive nanowires. Here, the amount of the organic binder includes both the first organic binder and the second organic binder, of course.

In the optical film, a mass ratio of the second organic binder to the first organic binder may be 1:0.01 to 1.5, 1:0.01 to 1.0, 1:0.01 to 0.8, or 1:0.01 to 0.5.

The present disclosure includes a display device including the optical film described above. The display device may be LCD, LED, OLED, AMOLED, QLED, a mobile display, and the like, but is not limited thereto.

The optical film described above may be used as at least a part of an anti-blooming film, a brightness enhancement film, a diffusion sheet, a lens sheet, a prism sheet, a reflective film, a light collecting lens, a protective film, an adhesive film, or the like, and also, or independently of this, may be used as a transparent conductive film.

The present disclosure includes a method for manufacturing the optical film described above. In the method for manufacturing an optical film described later, conductive nanowires, a network of conductive nanowires, a transparent substrate, an organic binder, an optical film manufactured, and the like are similar or identical to the description above for the optical film. Thus, the method for manufacturing an optical film includes the entire description above for the optical film.

The method for an optical film according to the present disclosure includes: a) applying a coating solution including conductive nanowires, an organic binder, and a solvent on at least one surface of a transparent substrate to prepare a coating film; and b) cleaning the one surface having the coating film positioned thereon.

The coating solution may include conductive nanowires, an organic binder, and a solvent, and as an organic material, may include only an organic binder. The coating solution may include 0.05 to 0.50 wt %, as an example, 0.80 to 0.30 wt % of the conductive nanowires.

The coating solution may include 0.05 to 2.50 wt %, as an example, 0.10 to 2.20 wt %, and as another example, 0.10 to 1.50 wt % of the organic binder. The weight ratio of the second organic binder to the first organic binder in the organic binder may be 1:1.5 to 3.0, and as an example, 1:1.8 to 2.5.

By the content of the organic binder and the weight ratio of the first organic binder and the second organic binder described above, the conductive nanowires may be stably and uniformly dispersed in the coating solution and also the conductive nanowires may maintain a stable fixed state on the transparent substrate even after the cleaning of step b), and both the optical properties and the electrical properties may be improved by cleaning.

The solvent may be a polar solvent, and the polar solvent may be a polar solvent having a solubility parameter of 20 MPa^{0.5} or more, as an example, a solubility parameter of 20 to 50 MPa^{0.5} or more, as another example, a solubility parameter of 30 to 50 MPa^{0.5} or more, and as another example, a solubility parameter of 40 to 50 MPa^{0.5} or more, at room temperature. As a substantial example, the solvent may be one or a mixed solvent of two or more selected from ethylene carbonate, nitromethane, ethanolamine, formamide, N,N-dimethylformamide, dimethyl sulfoxide, methanol, ethanol, aryl alcohol, 1-propanol, 2-propanol, 1-butanol, 2-butanol, isobutanol, benzyl alcohol, cyclohexanol, ethylene glycol monoethyl ether, diethylene glycol monomethyl ether, diethylene glycol monoethyl ether, ethylene glycol, glycerol, propylene glycol, dienylene glycol, triethylene glycol, dipropylene glycol, and water, but is not necessarily limited thereto. As described above, the solvent may be a single solvent or a mixed solvent of two or more polar solvents, satisfying the solubility parameter described above.

The coating solution may be applied by any method used for manufacturing a film having a uniform thickness by applying a liquid phase (including ink or slurry) in which a solid is dispersed, in the field of semiconductor or display manufacture. As an example, various methods such as coating, spraying, and printing may be used. As a specific example, spin coating, screen printing, ink-jet printing; bar coating; gravure coating; blade coating; roll coating; slot die; dipping or spraying; and the like may be used, but the present disclosure is not limited thereto.

In step a), if necessary, drying may be further performed. Drying may be performed by any method previously used for volatile removal of the solvent (dispersion medium) after applying a liquid phase (including ink or slurry) in which a solid is dispersed. As an example, the drying may be drying under reduced pressure, natural drying, hot air drying, heat drying, or a combination thereof, and a temperature at the time of hot air or heating may be 40 to 130° C., but the present disclosure is not limited by specific drying conditions or methods.

The cleaning in step b) may be one or two or more selected from dry cleaning, wet cleaning, and steam cleaning. As an example, the cleaning in step b) may be single cleaning of dry cleaning, wet cleaning, or steam (gas phase of a cleaning solution used in cleaning) cleaning. Otherwise, the cleaning in step b) may be multi-stage cleaning such as wet cleaning after dry cleaning, dry cleaning after wet cleaning, steam cleaning after dry cleaning, dry cleaning after steam cleaning, steam cleaning after wet cleaning, wet cleaning after stream cleaning, or dry cleaning, wet cleaning, and then dry cleaning again.

The wet cleaning may include cleaning a coating film with a cleaning solution which is a cleaning solution including a polar solvent, specifically a polar solvent. The polar solvent included in the cleaning solution may be, independently of the polar solvent of the coating solution, a solvent having a solubility parameter of 20 MPa^{0.5} or more, as an example, a solubility parameter of 20 to 50 MPa^{0.5}, as another example, a solubility parameter of 30 to 50 MPa^{0.5}, and as another example, a solubility parameter of 40 to 50 MPa^{0.5}, at room temperature. By wet-cleaning one surface of the transparent substrate having the coating film positioned thereon using the cleaning solution including the polar solvent, most of the first organic binder having a relatively high solubility parameter may be removed by cleaning, while the second organic binder having a relatively low solubility parameter remains on one surface to stably bind the nanowires to the transparent substrate. The polar solvent included in the cleaning solution may also be a single solvent or a mixed solvent of two or more solvents which satisfies the solubility parameter described above. As a specific example, the cleaning solution may be one or a mixed solvent of two or more selected from ethylene carbonate, nitromethane, ethanolamine, formamide, N,N-dimethylformamide, dimethyl sulfoxide, methanol, ethanol, aryl alcohol, 1-propanol, 2-propanol, 1-butanol, 2-butanol, isobutanol, benzyl alcohol, cyclohexanol, ethylene glycol monoethyl ether, diethylene glycol monomethyl ether, diethylene glycol monoethyl ether, ethylene glycol, glycerol, propylene glycol, dienylene glycol, triethylene glycol, dipropylene glycol, and water.

The wet cleaning may be performed by applying the cleaning solution on one surface of the substrate having the coating film positioned thereon or immersing the substrate having the coating film formed thereon in the cleaning solution. The cleaning solution may be applied by spraying, ultrasonic atomization, and the like, but the present disclosure is not limited to the specific application methods. In order to prevent undesired removal of a binder by a cleaning solution remaining after the cleaning, a step of removing the cleaning solution by air brushing after the cleaning may be performed, and the pressure in air brushing may be about 0.1 to 0.5 MPa, but is not limited thereto.

As described later, when the coating solution is applied on the transparent substrate and then a heat treatment is performed, the cleaning step may include spraying the cleaning solution including a polar solvent. The spraying of the cleaning solution may be sprayed using a spray nozzle, and the cleaning solution may be sprayed in a perpendicular direction to the transparent substrate (surface perpendicular (surface normal) direction of a transparent substrate surface). Thus, the first binder may be more selectively uniformly removed while maintaining a state in which the conductive nanowires are stably fixed to the transparent substrate by gelation of the second binder selected from cellulose ester and cellulose ether according to an exemplary embodiment at the time of a heat treatment. In spraying using a nozzle, the size of nozzle from which the cleaning solution is sprayed may be about 0.1 to 0.4 Φ, and the cleaning may be performed by moving a nozzle array or a transparent substrate at a speed of 0.1 m to 1 m/min in a longitudinal direction of the transparent substrate (a direction perpendicular to the width), in a state in which a plurality of nozzles are spaced apart in a width direction of the transparent substrate. Here, the spraying amount of the cleaning solution sprayed through each nozzle may be about 0.05 to 0.5 l/min, and a separation distance from the nozzle array to the nozzle may be about 10 to 100 mm.

In the wet cleaning, if necessary, cleaning may be performed by a temperature-controlled cleaning solution. As an example, the temperature of the cleaning solution may be 5° C. to 0.95 T_{b} (T_{b}=a boiling point under normal pressure of a polar solvent included in the cleaning solution, ° C.). By controlling the temperature of the cleaning solution with the solubility parameter of the polar solvent included in the cleaning solution, the removal degree of the first organic binder and/or the remaining degree of the second organic binder may be more selectively adjusted.

The dry cleaning may include a plasma treatment. That is, the dry cleaning may include plasma-treating one surface of the substrate having the coating film positioned thereon. The plasma may be low-pressure plasma or normal-pressure plasma, and independently of this, may be thermal plasma or low-temperature plasma. The plasma is supplied to one surface of the substrate having the coating film positioned thereon and the organic binder exposed to one surface of the substrate (including the coating film) may be removed on the surface.

The steam cleaning may be performed using a steam of a solution (hereinafter, referred to as a second cleaning solution) which is similar or identical to the cleaning solution used in the wet cleaning described above. Specifically, the steam cleaning may include supplying a vaporized second cleaning solution to one surface of the substrate having the coating film positioned thereon. The second cleaning solution may be thermally vaporized, and the temperature of the vaporized second cleaning solution may be 1 T_{b} to 1.5 T_{b} (T_{b}=a boiling point under normal pressure of a polar solvent included in the second cleaning solution, ° C.), but is not limited thereto.

After the coating solution is applied on the transparent substrate by step a), a step of heat-treating the transparent substrate having the conductive nanowires positioned on one surface by the application of the coating solution may be further performed before step b), after step b), or before step b) and after step b), respectively. As an example, before cleaning, after cleaning, or before and after cleaning, the heat treatment may be performed, respectively. The heat treatment may be performed at 70 to 130° C., as a specific example, at 100 to 130° C. A heat treatment time may be 5 to 200 seconds, but is not limited thereto.

The heat treatment is effective when the second organic binder is cellulose ester and cellulose ether. The cellulose ester or cellulose ether-based second organic binder may be thermally gelled by the heat treatment to more strongly fix the nanowires to the substrate.

Thus, the second organic binder (cellulose ester or cellulose ether-based binder) may be gelled by the heat treatment before cleaning to prevent the nanowires from being partially detached from the transparent substrate in a cleaning process, and in cleaning, the undesired removal of the second binder is suppressed, and the first binder may be more selectively removed. Here, in the heat treatment before cleaning, drying (volatile removal of a solvent from a coating solution) may be additionally simultaneously performed, and otherwise, drying may be performed independently of the heat treatment before cleaning, before or after gelation.

In addition, the heat treatment may be performed even after cleaning is performed. By gelling the second organic binder again by the heat treatment after cleaning, a high sheet resistance uniformity, an excellent sheet resistance (average sheet resistance) of 25 Ω/sq or less, excellent haze properties of 2% or less, and also excellent mechanical properties may be secured, and thus, it may be very effectively used in a flexible or rollable display.

Thus, the method for manufacturing an optical film according to an exemplary embodiment may include a) applying a coating solution including conductive nanowires, an organic binder, and a solvent on at least one surface of the transparent substrate to prepare a coating film; heat-treating the transparent substrate having the coating film formed thereon at 70 to 130° C., as a specific example, 100 to 130° C. for 5 to 200 seconds (first heat treatment); b) after the first heat treatment, vertically spraying a cleaning solution including a polar solvent on one surface of the transparent substrate having the conductive nanowires positioned thereon by the application to perform cleaning; and heat-treating the cleaned transparent substrate at 70 to 130° C., as a specific example, 100 to 130° C. for 5 to 200 seconds (second heat treatment).

By performing the first heat treatment and the second heat treatment before and after cleaning, though a conductive path is formed only by a physical contact without welding between nanowires, a sheet resistance of 93% or more of an average sheet resistance before a test may be maintained even in the bending test of 10000 times at a curvature of 5 mm, and no significant deterioration of optical properties may occur.

### Example 1

A polyethylene terephthalate (PET) film was used as a transparent substrate, silver nanowires (short axis diameter: 20 nm, length: 20-25 μm) were used, and a coating solution including a first organic binder which was polyhydroxyethylmethacrylate (solubility parameter: 26.9 MPa^{0.5}), a second organic binder which was a cellulose ether-based binder having a solubility parameter of 20.2 MPa^{0.5}, and water which was a polar solvent was prepared. The content of the silver nanowires in the coating solution was 0.20 wt %, the mass ratio of the first organic binder to the second organic binder in the coating solution was 2:1, and the coating solution included 0.50 wt % of the binder (first organic binder+second organic binder).

Slot die coating was used to apply the coating solution on a PET film, so that the silver nanowires were applied at 0.056 g/m² per unit area of the PET film. After performing application using slot die coating, a heat treatment was performed at 110° C. for 60 seconds (first heat treatment), and purified water was sprayed on the film subjected to the first heat treatment through nozzles to perform cleaning. The purified water was vertically sprayed on the PET film, a moving speed of the spray nozzle was 0.5 m/min, an amount of purified water sprayed through nozzles of 0.2 D was 0.1 L/min, and a spacing between spray nozzles in a width direction of the PET film was 50 mm After performing purified water spray, the cleaning solution was removed by air brushing (0.3 MPa), and a heat treatment at 120° C. for 60 seconds was performed again (second heat treatment) to manufacture an optical film.

### Example 2

An optical film was manufactured in the same manner as in Example 1, except that in the application of the coating solution, the silver nanowires were applied at 0.097 g/m² per unit area of the PET film.

### Comparative Example 1

An optical film was manufactured in the same manner as in Example 1, except that cleaning was not performed, and drying at 100° C. for 2 minutes was performed instead of the first heat treatment.

### Comparative Example 2

An optical film was manufactured in the same manner as in Example 2, except that cleaning was not performed, and drying at 100° C. for 2 minutes was performed instead of the first heat treatment.

### Comparative Example 3

An optical film was manufactured in the same manner as in Example 1, except that only the second organic binder which was a cellulose ether-based binder was used instead of the first organic binder and the second organic binder, and the coating solution included (only) 0.50 wt % of the second organic binder as a binder.

### Comparative Example 4

An optical film was manufactured in the same manner as in Example 1, except that only the first binder was used instead of the first organic binder and the second organic binder, and the coating solution included (only) 0.50 wt % of the first organic binder as a binder.

An average sheet resistance and a sheet resistance uniformity were determined as follows: the optical films of 30 mm×30 mm manufactured in the examples and the comparative examples were equally divided into 9 areas, the sheet resistance of each area was measured 10 times randomly and an average sheet resistance and a sheet resistance standard deviation were calculated from a total of 90 measurement results of the sheet resistance, and the sheet resistance uniformity was calculated according to the equation of “sheet resistance uniformity (%)=[1−(standard deviation of sheet resistance)/(average of sheet resistance)]×100”.

TABLE 1

| | Average sheet | Sheet resistance | Haze |
|---|---|---|---|
| | resistance (Ω/sq) | uniformity (%) | (%) |
| Comparative Example 1 | 30.4 | 91% | 1.6 |
| Example 1 | 24.9 | 91% | 1.4 |
| Comparative Example 2 | 21.3 | 93% | 2.1 |
| Example 2 | 18.1 | 93% | 1.7 |
| Comparative Example 3 | 30.6 | 89% | 1.7 |
| Comparative Example 4 | 67 | 77% | — |

As seen from Comparative Examples 1 and 2 of Table 1, when the loading amount of nanowires was increased for decreasing a sheet resistance, optical properties were deteriorated, and when the loading amount of nanowires was decreased for improving optical properties, electrical properties were deteriorated. That is, since the electrical properties and the optical properties are conventionally traded off with each other, it was very difficult to satisfy both the electrical properties having a sheet resistance of about 25 Ω/sq and the optical properties having a haze of 2% or less.

However, it was found that when a cleaning process was performed according to an exemplary embodiment of the present disclosure, the electrical properties and the optical properties in a trade-off relationship were greatly improved, and it is possible to manufacture an optical film satisfying both the electrical properties having a sheet resistance of about 25 Ω/sq and the optical properties of a haze of 2% or less.

In addition, it was confirmed from Comparative Example 3 that any significant change in physical properties by cleaning was not shown with the cellulose ether-based second binder alone, the nanowires were rearranged without being fixed to the transparent film in the cleaning process and the uniformity was greatly deteriorated with the first binder alone, and also, as a result of a 5 mm one-way bending test, most of silver nanowires were detached from the substrate within 200 times.

However, it was confirmed that as a result of the 5 mm one-way bending test, the optical film manufactured in Example 2 maintained a sheet resistance of 94% or more of an average sheet resistance before the test even in a bending test of 10000 times.

It was confirmed in Example 2 that Fourier transform infrared spectroscopy (FT-IR) was performed before washing and after washing, and the organic binder was partially washed out by the washing, and both of the organic binders remained even after the washing. Also, as a result of using 9 samples to measure a change in the weight of the film before and after washing, it was confirmed that a content change of about 20% in the organic binder occurred.

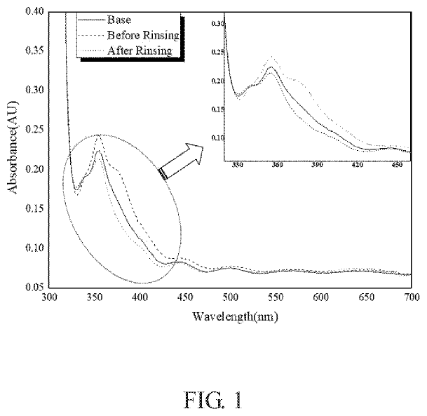

FIG. 1 is a drawing in which the UV-Vis absorption spectrum of a PET film (base of FIG. 2) which is a transparent substrate and the optical film (sample) before and after washing in Example 2 was measured and illustrated. As seen from FIG. 1, the absorption rate was decreased overall by washing, and an absorption peak was shown at 340 nm, 355 nm, and 374 nm before washing, but the absorption peak shown at 374 nm disappeared after washing and two peaks at 340 nm and 355 nm were shown.

Hereinabove, although the present disclosure has been described by specific matters, exemplary embodiments, and drawings, they have been provided only for assisting in the entire understanding of the present disclosure. Therefore, the present disclosure is not limited to the exemplary embodiments. Various modifications and changes may be made by those skilled in the art to which the present disclosure pertains from this description.

Therefore, the spirit of the present disclosure should not be limited to the above-described exemplary embodiments, and are intended to fall within the scope and spirit of the disclosure.

1. An optical film comprising: a transparent substrate; a network of conductive nanowires positioned on at least one surface of the transparent substrate; and an organic binder,
wherein the organic binder includes a first organic binder and a second organic binder with different solubility parameters (Hildebrand solubility parameter, δ) from each other, a difference in the solubility parameter between the first organic binder and the second organic binder being 5 MPa^{0.5} or more, and
the optical film has a haze of 2.0% or less and a sheet resistance of 25 Ω/sq or less.

2. The optical film of claim 1, wherein the optical film has a sheet resistance uniformity which is defined by the following Equation 1 and satisfies the following Equation 2:
Sheet resistance uniformity (%)=[1−(standard deviation of sheet resistance)/average of sheet resistance]×100 Equation 1
90(%)≤sheet resistance uniformity (%). Equation 2

3. The optical film of claim 1, wherein in a UV-Vis absorption spectrum of the optical film, a center of an absorption peak is positioned in a wavelength region of 350 to 360 nm.

4. The optical film of claim 3, wherein in the UV-Vis absorption spectrum of the optical film, no center of the absorption peak is positioned in a wavelength region of 365 nm to 385 nm.

5. The optical film of claim 1, wherein the network of conductive nanowires is a network formed by a physical mutual contact of randomly positioned metal nanowires.

6. The optical film of claim 1, wherein the optical film includes 10 to 1000 parts by weight of the organic binder with respect to 100 parts by weight of a total weight of the conductive nanowires forming the network.

7. The optical film of claim 1, wherein the first organic binder having a relatively high solubility parameter has a solubility parameter of 22.0 MPa^{0.5} or more.

8. The optical film of claim 1, wherein the optical film has a sheet resistance of 20 Ω/sq or less.

9. The optical film of claim 1, wherein the conductive nanowires are silver nanowires.

10. The optical film of claim 1, wherein the conductive metal nanowires have a diameter of 10 to 30 nm.

11. A display device comprising the optical film of claim 1.

12. A method for manufacturing an optical film, the method comprising:
a) applying a coating solution including conductive nanowires, an organic binder, and a solvent on at least one surface of a transparent substrate to prepare a coating film; and
b) cleaning the one surface of the transparent substrate having the coating film positioned thereon.

13. The method for manufacturing an optical film of claim 12, wherein the cleaning in b) is one or two or more selected from dry cleaning, wet cleaning, and steam cleaning.

14. The method for manufacturing an optical film of claim 12, wherein the cleaning includes spraying a cleaning solution including a polar solvent.

15. The method for manufacturing an optical film of claim 14, wherein the cleaning solution has a solubility parameter of 20 MPa^{0.5} or more.

16. The method for manufacturing an optical film of claim 12, further comprising: before b), after b), or before and after b), respectively, heat-treating the transparent substrate having the conductive nanowires positioned on the one surface by the applying of the coating solution.
